(19) United States
(12) Patent Application Publication
(10) Pub. No.: US 2004/0093325 A1
(43) Pub. Date: May 13, 2004

(54) System and method for location influenced network search

(75) Inventors: Dwip N. Banerjee, Austin, TX (US); Craig Henry Becker, Austin, TX (US); Kumar Ravi, Cedar Park, TX (US)

Correspondence Address: Joseph T. Van Leeuwen, P.O. Box 81641, Austin, TX, 78708-1614, US

(73) Assignee: International Business Machines Corporation, Armonk, NY

(21) Appl. No.: 10/290,354

(22) Filed: Nov. 7, 2002

(51) Int. Cl. G06F 7/00

(52) U.S. Cl. 707/3

(57) ABSTRACT

A system and method for location influenced network search is presented. A user uses a query device to send a location-based search request to a search engine. The location-based search request includes a user query request and geographical coordinates corresponding to the user's location. The search engine performs a network search using the user query request, and receives a query result corresponding to the query request which includes one or more URL links. The search engine identifies an organization corresponding to the user's location by comparing the geographical coordinates with one or more organization coordinates. The search engine retrieves contextual keywords corresponding to the identified organization, and filters the query result using the contextual keywords. The search engine includes organization data or manufacturer data to the filtered query result, and sends the query result to the query device for the user to view.

### BACKGROUND OF THE INVENTION

1. Technical Field

The present invention relates in general to a system and method for a location influenced network search. More particularly, the present invention relates to a system and method for refining a search request using contextual keywords corresponding to the location of a query device.

2. Description of the Related Art

Computer systems today have the capability of retrieving a vast amount of information from a local network, such as an organization's local area network, as well as a global network, such as the Internet. A user typically uses a search engine, such as Yahoo or Google, to increase a computer system's probability of retrieving information corresponding to the user's interest. These search engines accept a user's search request, typically in Boolean format, and return search results in the form of URL's of locations that include information corresponding to the search request.

The preciseness of a user's search request often determines whether a computer system accurately isolates a URL corresponding to the user's interest. For example, a user may enter “salsa” into a search engine, and the search engine retrieves hundreds of URL's corresponding to salsa the sauce and salsa the dance. In this example, the user adds either “dance” or “sauce” to his search request in order to isolate URL's of interest. The user may enter more words to accurately describe the user's interest. However, a search engine may still return hundreds of URL's if the user's topic of interest includes a vast amount of information on a global network, such as the Internet. In many cases, a user sorts through many URL's before finding URL's of interest. Additionally, a word or phrase may have many meanings, and just by looking at the URL, users may not be able to determine the contents of the site. Sorting through URL's using a desktop computer with a large monitor may be cumbersome, but manageable.

However, wireless technologies, such as Wireless Access Protocol (WAP), are being implemented to provide Internet access to mobile devices, such as cellular phones and personal digital assistants (PDA's). WAP is a standard protocol for the transmission of data over low bandwidth wireless networks which allows a mobile device to browse the Internet. A wireless network is typically implemented using two key components, a gateway and a microbrowser (i.e. mobile device software application). Together, these components enable mobile devices to access information on the Internet.

A challenge found with using a mobile device to perform broad network searches is the small size of the mobile device. The user is unable to sort through many URL's and therefore is required to perform a precise search request which includes multiple words. However, a mobile device typically has a small and limited keypad and is cumbersome for a user to type in multiple words into a search request.

In addition, wireless bandwidth is expensive. A challenge found in performing a broad network search is the amount of bandwidth that a result of the broad network search consumes while sending the result to a mobile device.

A wireless user typically inquires about a subject based upon his particular location. For example, if the user is at a grocery store, a user's search request most likely relates to food. Using another example, if a user is at a hardware store, such as Home Depot, the user's inquiry most likely relates to homeowner activity, such as building or gardening. What is needed, therefore, is a way to automatically refine a user's search request based upon the user's location.

### SUMMARY

It has been discovered that the aforementioned challenges are resolved by providing a contextual based search service that refines network searches using contextual keywords corresponding to a particular organization location. An organization registers with a contextual based search service and provides a search engine with its geographical coordinates (i.e. organization coordinates), organization data, such as promotional information, product locator information, and contextual keywords. The search engine uses the organization's information when the search engine receives a location-based search request from a user that is at the organization's location.

A user is at an organization location and wishes to receive information about a particular subject corresponding to the organization. For example, the user may be at a hardware store, and wishes to receive information about “Delta” faucets. The user enters “delta” into his query device as a query request. The query device may be an electronic device capable of sending requests to a search engine, such as a cellular phone, a computer, or a personal digital assistant (PDA). The query device also includes a location device, such as a Global Positioning System (GPS) receiver, that obtains geographical coordinates corresponding to the user's location. The query device includes the user's query request and geographical coordinates in a location-based search request, and sends the location-based search request to a search engine.

The search engine receives the location-based search request, extracts the user's query request from the location-based search request, and sends the query request to an index manager through a computer network, such as the Internet. The index manager is an application that manages a search engine's indexes. A search engine creates the indexes when the search engine is probing the Internet for information. The indexes include URL locations and keywords that are included in the URL's corresponding web page. The index manager searches various indexes, and identifies links (i.e. URL locations) that correspond to the query request. The index manager includes the identified links in a query result, and sends the query result to the search engine through a computer network. Using the example described above, the query result includes links corresponding to “Delta faucets” as well as links corresponding to “Delta Airlines”.

The search engine determines whether the organization where the user is located is registered with the search engine by matching the geographical coordinates included in the location-based search request with one or more organization coordinates included in one or more organization records. If the search engine detects a match, the search engine sets a “registered” flag. Some organizations, however, may not store their organization coordinates in their corresponding organization record. For example, Home Depot may have a corporate account and the corporate account may not have each Home Depot's geographical location (organization coordinates) in Home Depot's organization record.

If the search engine does not match the geographical coordinates with one of the organization coordinates, the search engine sends a reverse mapping request which includes the geographical coordinates to a reverse mapper. The reverse mapper is an application that receives geographical coordinates (i.e. longitude and latitude), and matches the geographical coordinates to an organization name. Using the example described above, the reverse mapper response may include the organization name “Home Depot”. The search engine receives the response and matches the organization name with one or more organization names included in one or more of the organization records. If the search engine detects a match, the search engine sets the registered flag.

If the organization is registered (i.e. the registered flag is set), the search engine retrieves the organization's contextual keywords from the organization's corresponding organization record. Using the example described above, one of Home Depot's contextual keywords may be “household”. The search engine filters the query result using the organization's contextual keywords. Using the example described above, the search engine uses “household” to filter “Delta” links which result in “Delta faucets” links remaining while “Delta Airline” links are removed.

The search engine retrieves the organization's organization data from the organization's registered organization record, and includes the organization data with the query result. Using the example described above, the organization data may include Home Depot coupons or an aisle number where the user may locate Delta faucets. The search engine formats the query result, and sends the query result to the query device. The query device notifies the user that it received a response corresponding to the user's location-based search request.

In one embodiment, the search engine uses the organization's contextual keywords to perform a contextual query request. Using the example described above, the search engine includes “Delta” and “household” in the query request. In this example, the query result includes “Delta faucets” links but does not include “Delta Airlines” links and therefore the search engine may not perform a filtering step using the contextual keywords.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing an organization and a manufacturer sending information to a query manager;

FIG. 2 is a diagram showing a user sending a location-based search request to a search engine, and receiving a query result corresponding to the location-based search request;

FIG. 3 is a high-level diagram showing steps taken in performing a search using a combination of contextual keywords and a search request, and sending a formatted search result to a query device;

FIG. 4 is a high-level diagram showing steps taken in performing a search using a search request, filtering a search result using one or more contextual keywords, and sending a formatted search result to a query device;

FIG. 5 is a flowchart showing steps taken in determining whether a location is registered with a search engine;

FIG. 6 is a flowchart showing steps taken in formatting a search response and using a user's preference information and a location's organization data;

FIG. 7 is a flowchart showing steps taken in using a query device to send a request to a search engine;

FIG. 8 is a flowchart showing steps taken in a search engine receiving a preferences configuration request from a query device;

FIG. 9 is a diagram showing a manufacturer and two organizations sending data to a search engine; and

FIG. 10 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

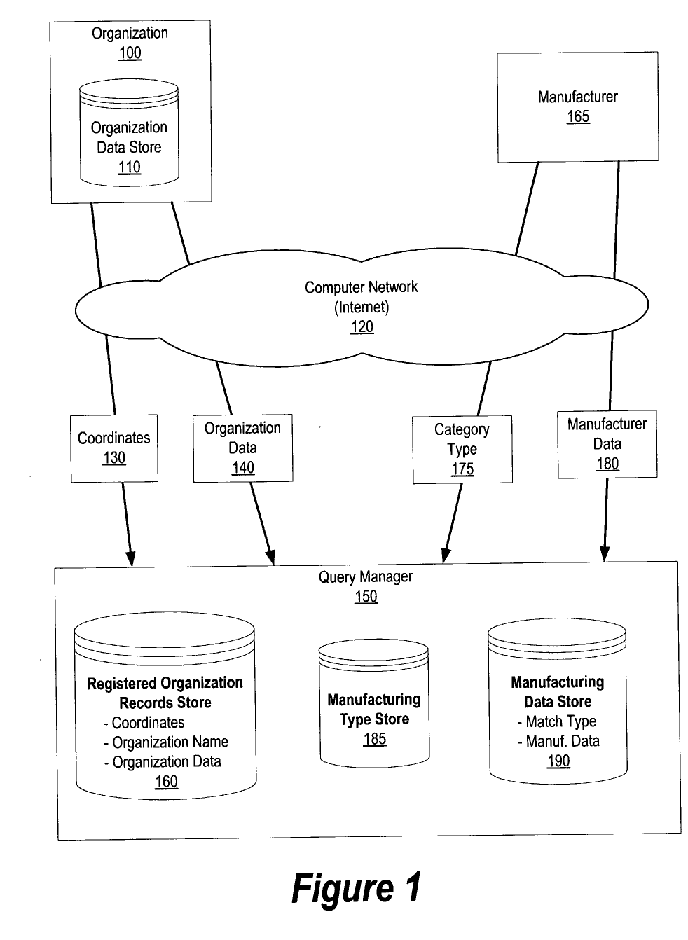

FIG. 1 is a diagram showing an organization and a manufacturer subscribing with a contextual based search service, such as query manager 150. Organization 100 is an organization with particular geographical coordinates and may be a non-profit organization, a for-profit business, or a public location, such as a city park. For example, organization 100 may be a grocery store located at 5^{th} Street and Main Street in Austin, Tex. Query manager 150 may be a search engine, such as Google or Yahoo, which provides a contextual based search service.

A contextual based search service receives a location based search request from a user. The location-based search request includes a user query request and geographical coordinates corresponding to the location of the user (i.e. GPS coordinates). Query manager 150's contextual based search service searches one or more indexes using the user's query request in relation to the location of the user. For example, a user may be in a grocery store and the user's query request may be “salsa”. In this example, the contextual based search service identifies that the user is at a grocery store and is interested in “salsa” the sauce, and not “salsa” the dance.

During the subscription process, query manager 150 may charge organization 100 for using the contextual based search service. Query manager 150 may have various levels of service with various fees associated with the service levels. For example, organization 100 may be a grocery store and wishes to inform its customers of sales, popular recipes, and coupons that the customer may use in its store based upon a customer's query request. In this example, query manager 150 may charge organization 100 at a rate based upon how much storage area organization 100 requires in order to store organization 100's data.

Organization 100 includes organization data store 110. Organization data store 110 includes relevant information that organization 100 wishes to provide to query manager 150. Using the example described above, organization data store 110 may include coupon information, product locator information, and recipe information. Organization data store may also include product association information. For example, if a user searches on “salsa”, the user may receive a response that includes association information regarding “chips”. Organization data store 110 also includes geographical coordinate information corresponding to organization 100. Organization data store 100 may be stored on a non-volatile storage area, such as a computer hard drive.

Organization 100 sends coordinates 130 to query manager 150 through computer network 120, such as the Internet. Coordinates 130 include geographical coordinate information corresponding to organization 100. Query manager 150 receives coordinates 130 and stores the geographical coordinates in an organization record corresponding to organization 100 located in registered organization records store 160. Registered organization records store 160 includes a record for each organization which is registered with query manager 150. Each organization record may include an organization's name, its geographical location, and its organization data (i.e. coupon information, recipes, etc.). Organization records store 160 may be stored on a nonvolatile storage area, such as a computer hard drive.

Organization 100 also sends organization data 140 to query manager 150 through computer network 120, such as the Internet. Organization data 140 includes information that organization 100 wishes query manager 150 to utilize when one of organization 100's customers initiates a query request. Using the example described above, organization data 140 may include recipe and coupon information. Organization data 140 also includes contextual keywords that query manager 150 uses to filter a customer's query request. Using the example described above, organization data 140 includes contextual keywords that distinguish organization 100 as a grocery store, such as “food”.

Manufacturer 165 subscribes with query manager 150 and provides category type 175 to query manager 150 through computer network 120. Category type 175 corresponds to organizations that carry products that manufacturer 165 produces. For example, manufacturer 165 may be “Delta Faucets” and have corresponding category types such as plumbing, hardware, and home improvement. Query manager 150 receives category type 175, and stores it in manufacturing type store 185. Manufacturing type store 185 may be stored on a non-volatile storage area, such as a computer hard drive.

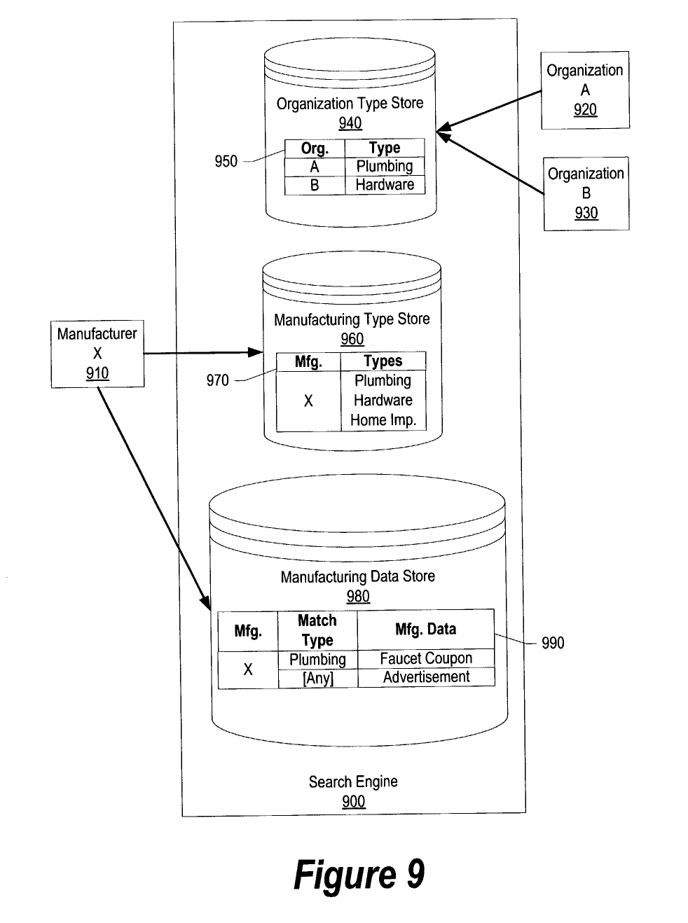

Manufacturer 165 also sends manufacturer data 180 to query manager 150 through computer network 120. Manufacturer data 180 includes various levels of information that is included in a response to a user depending on the location of the user (see FIG. 9 and corresponding text for further details regarding manufacturer data insertion). Query manager 150 receives manufacturer data 180 and stores it in manufacturing data store 190. Manufacturing data store 190 may be stored on a non-volatile storage area, such as a computer hard drive.

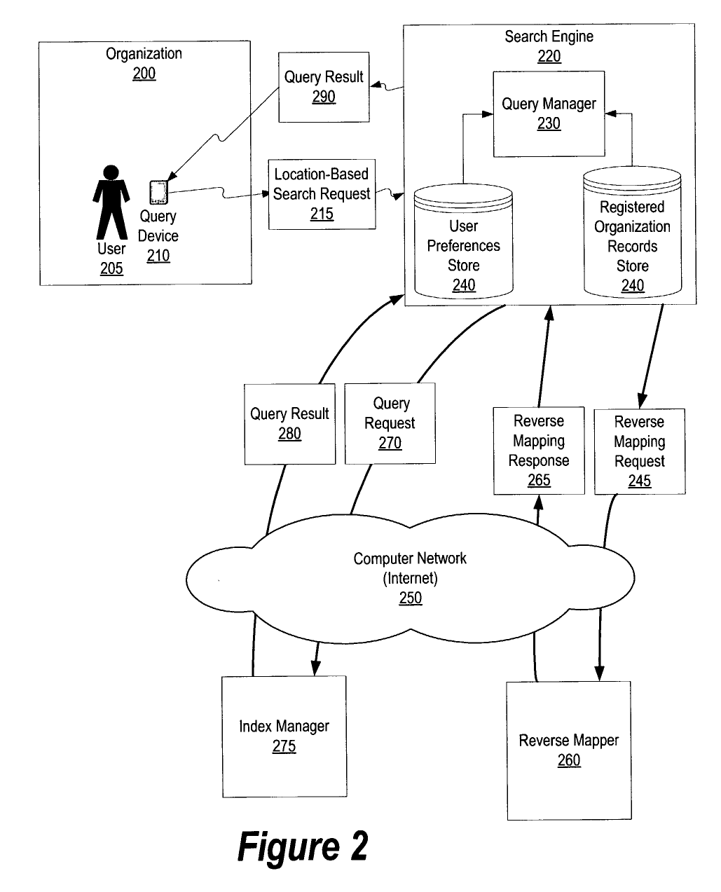

Query manager 150 is now able to process a user's location-based search request and send a query result to the user that includes organization data and manufacturer data (see FIG. 2 and corresponding text for further details regarding query requests).

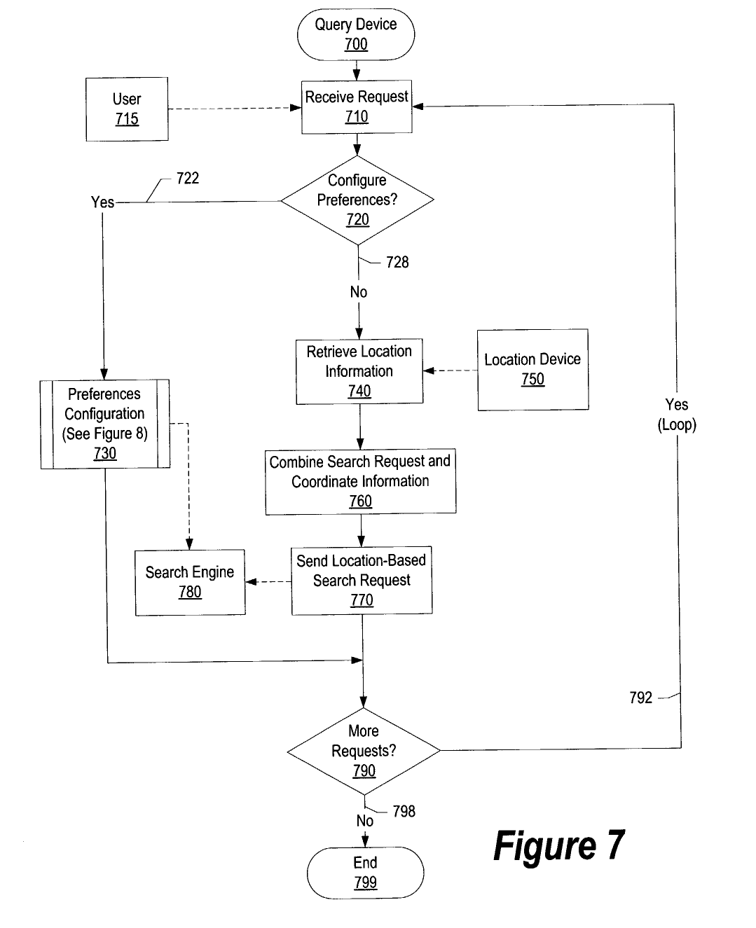

FIG. 2 is a diagram showing a user sending a location-based search request to a search engine, and receiving a query result corresponding to the location-based search request. User 205 is at organization 200 and wishes to receive information corresponding to a particular subject in relation to organization 200. For example, user 205 may be at a hardware store, and wishes to receive information about “Delta” faucets. User 205 enters “delta” as a query request in query device 210. Query device 210 may be an electronic device capable of sending requests to a search engine, such as a cellular phone, a computer, or a personal digital assistant (PDA). Query device 210 also includes a location device, such as a GPS receiver, that obtains geographical coordinates corresponding to user 205's location. Query device 210 sends location-based search request 215, which includes the geographical coordinates and user 205's query request, to search engine 220 (see FIG. 7 and corresponding text for further details regarding location-based search request generation).

Search engine 220 receives location-based search request 215 from query device 210. Search engine 220 includes query manager 230 which is responsible for managing location-based search requests. Query manager 230 extracts the user query request from location-based search request 215. Query manager 230 includes the user query request in query request 270, and sends query request 270 to index manager 275 through computer network 250, such as the Internet. Index manager 275 is an application that manages a search engine's indexes. A search engine creates the indexes when the search engine is probing the Internet for information. The indexes include URL locations and keywords that are included in the URL's corresponding web page. Index manager searches various databases, and identifies links (i.e. URL locations) that correspond to query request 270. Index manager 275 includes the identified links in query result 280, and sends query result 280 to search engine 220 through computer network 250. Using the example described above, query result 280 includes links corresponding to “Delta faucets” as well as links corresponding to “Delta Airlines”.

Query manager 230 determines whether organization 200 is registered with search engine 220 by matching the geographical coordinates included in location-based search request 215 with one or more organization coordinates included in organization records that are located in registered organization records store 240. If query manager 230 detects a match, query manager 230 sets a “registered” flag. Some organizations, however, may not store their organization coordinates in their corresponding organization record. For example, Home Depot may have a corporate account and the corporate account may not have each Home Depot's geographical location (organization coordinates) in Home Depot's organization record. If query manager 230 does not match the geographical coordinates with one of the organization coordinates, search engine 220 sends reverse mapping request 245 which includes the geographical coordinates to reverse mapper 260 through computer network 250, such as the Internet.

Reverse mapper 260 is an application that converts geographical coordinates to an organization name. Reverse mapper 260 “reverse maps” the coordinates, and sends reverse mapping response 265 which includes a corresponding organization name to search engine 220 through computer network 250. Using the example described above, reverse mapping response 265 may include the organization name “Home Depot”. Query manager 230 receives reverse mapping response 265 and matches the organization name with one or more organization names included in organization records located in registered organization records store 240. If query manager 230 detects a match, query manager sets the registered flag.

If organization 200 is registered (i.e. the registered flag is set), query manager 230 retrieves organization 200's contextual keywords from organization records store 240. Organization 200 previously stored contextual keywords in organization records store (see FIG. 1 and corresponding text for further details regarding contextual keyword storage). Using the example described above, one of Home Depot's contextual keywords may be “household”. Query manager 230 filters query result 280 using the organization's contextual keywords. Using the example described above, query manager 230 uses “household” to filter “Delta” links which result in “Delta faucets” links remaining while “Delta Airline” links are removed.

Query manager 230 retrieves organization 200's organization data from registered organization records store 240, and includes the organization data to the query result. Using the example described above, the organization data may include Home Depot coupons or an isle number where user 205 may locate Delta faucets. Query manager 230 formats the query result, and sends query result 290 to query device 210. Query device 210 notifies user 205 that it received a response corresponding to user 205's location-based search request.

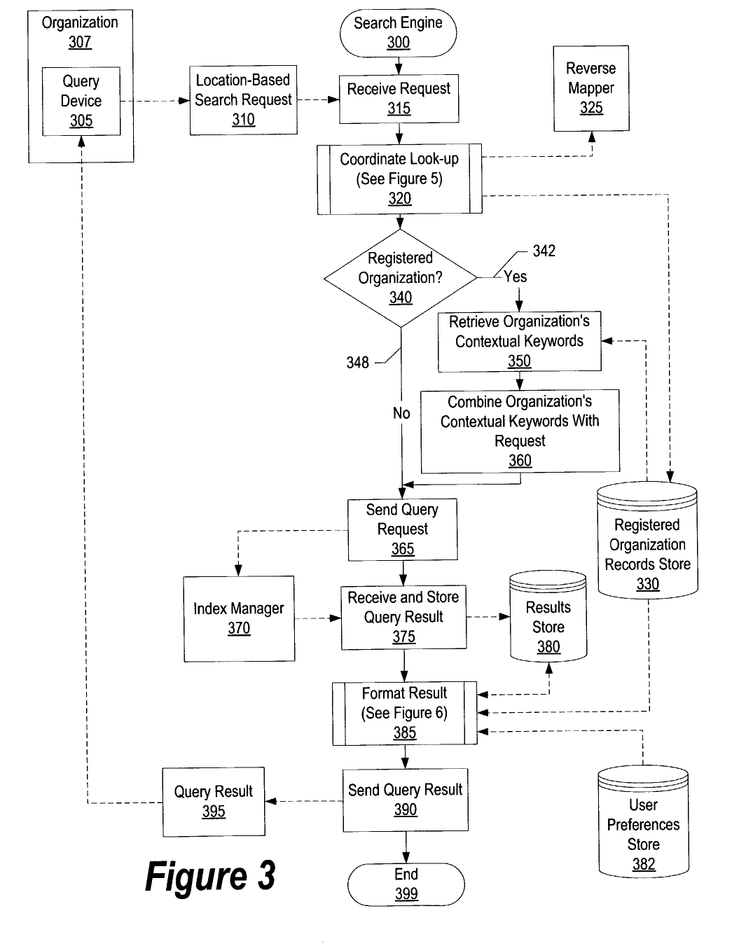

In one embodiment, query manager 230 uses an organization's contextual keywords to perform a contextual query request. Using the example described above, query manager 230 includes “Delta” and “household” in query request 270. In this example, query result 280 includes “Delta faucets” links but does not include “Delta Airlines” links and therefore query manager 230 may not perform a filtering step using the contextual keywords (see FIG. 3 and corresponding text for further details regarding this embodiment).

FIG. 3 is a high-level diagram showing steps taken in performing a location-based search request by combining a user query request with one or more contextual keywords, performing a single query request using the combination, and sending a query result to a query device. The query device, such as query device 305, is located at a particular organization, such as organization 307. Search engine processing commences at 300, whereupon location-based search request 310 is received from query device 305 (step 315). Location-based search request 310 includes geographical coordinates corresponding to organization 307's location as well as a user query request. For example, organization 307 may be a baseball field and the user query request includes the word “Bonds”.

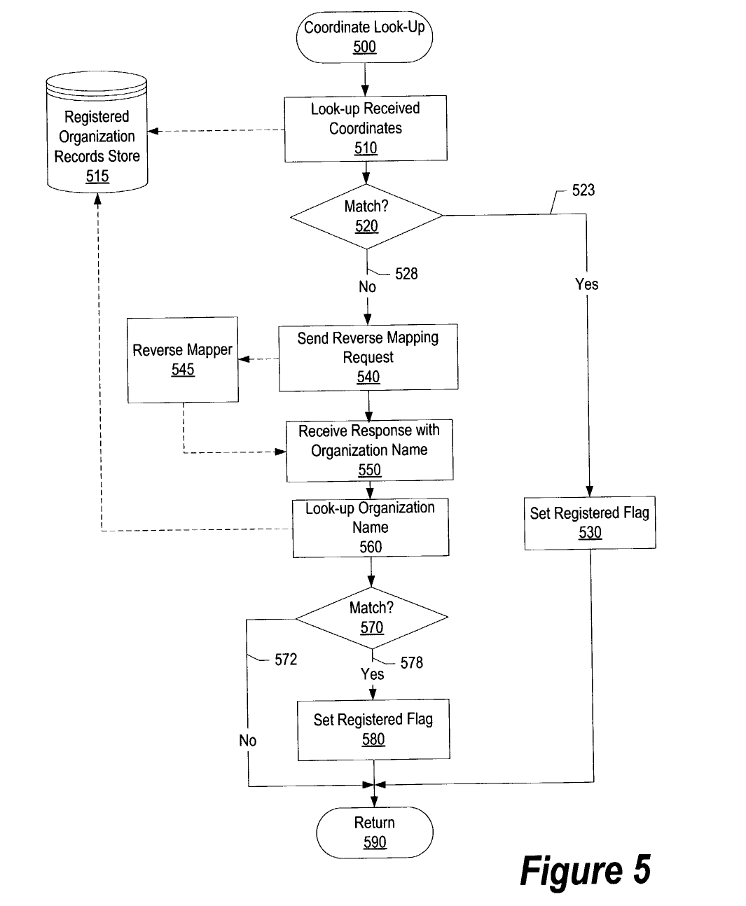

Processing uses the organization's geographical coordinates to determine if location 307 is registered by comparing the graphical coordinates with organization coordinates included in organization records located in registered organization records store 330 (pre-defined process block 320, see FIG. 5 and corresponding text for further details). Registered organization records store 330 may be stored on a non-volatile storage area, such as a computer hard drive. Processing may also use reverse mapper 325 to identify the name of organization 307 using the geographical coordinates if processing does not identify organization 307's geographical coordinates in registered organization records store 330.

A determination is made as to whether organization 307 is registered (decision 340). If organization 307 is a registered organization, decision 340 branches to “Yes” branch 342 whereupon processing retrieves organization 307's contextual keywords from registered organization records store 330 (step 340). Using the example described above, one of organization 307's contextual keywords may be “baseball”. Organization 307 previously stored the contextual keywords in registered organization records store 330 (see FIG. 1 and corresponding text for further details regarding contextual keyword storage).

Processing combines the user's query request with the contextual keywords at step 360, resulting in a contextual query request. Using the example described above, processing generates a contextual query request with the words “Bonds” and “baseball”. By using the contextual keywords to refine the user's query request, processing receives a query result relative to the user's interest. Using the example described above, if a query request does not include the contextual keyword “baseball”, processing may receive query results corresponding to “Barry Bonds” as well as “savings bonds” and “convertible bonds”.

On the other hand, if organization 307 is not a registered organization, decision 340 branches to “No” branch 348 bypassing contextual keyword combination steps. A query request is sent to index manager 370 at step 365. Index manager 370 is an application that manages a search engine's indexes. A search engine creates the indexes when the search engine is probing the Internet for information. The indexes include URL locations and keywords that are included in the URL's corresponding web page. Processing receives a query result from index manager 370 and stores the result in result store 380 (step 375). Using the example described above, if organization 307 is a registered organization, the result may include information limited to “Barry Bonds”. Another example is that if organization 307 is not registered, the result may include information about “Barry Bonds”, “savings bonds”, and “convertible bonds”. Result store 380 may be stored in a nonvolatile storage area, such as a computer hard drive.

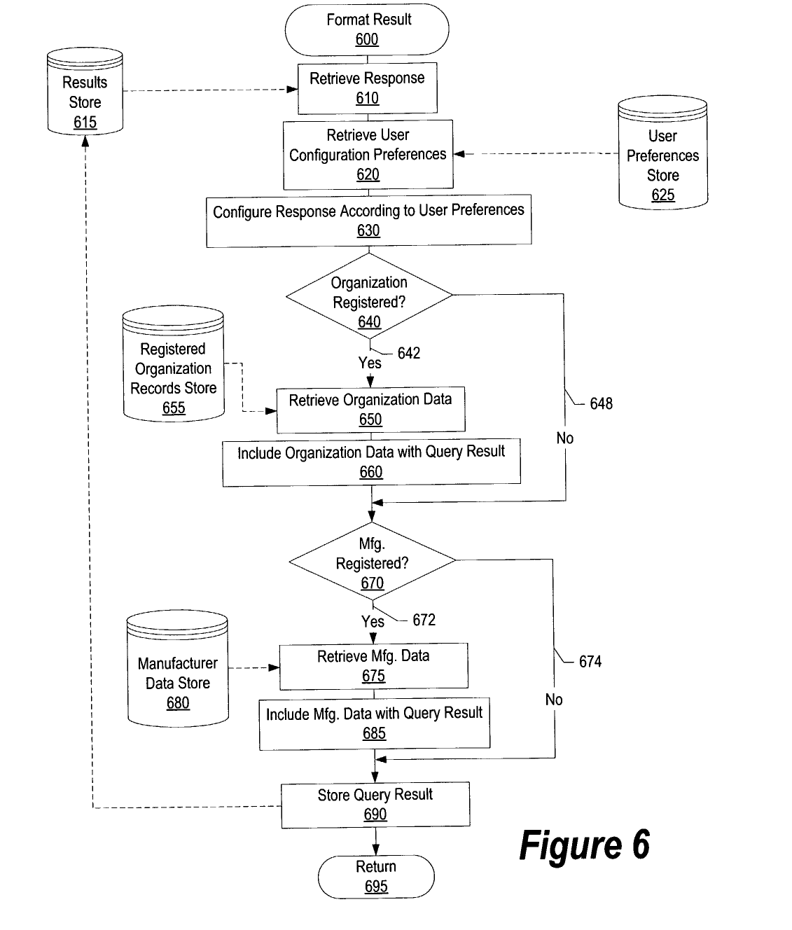

Processing formats the result using user preference information located in user preference store 382. For example a user may configure the search engine to not send graphical images to his query device due to the query device's small display size. User preference store 382 may be stored on a non-volatile storage area, such as a computer hard drive. If organization 307 is registered, processing adds organization data (i.e. coupon information, product information) corresponding to organization 307 which is located in organization records store 330 (pre-defined process block 385, see FIG. 6 and corresponding text for further details) Processing sends query result 395 to query device 305 at step 390, and processing ends at 399.

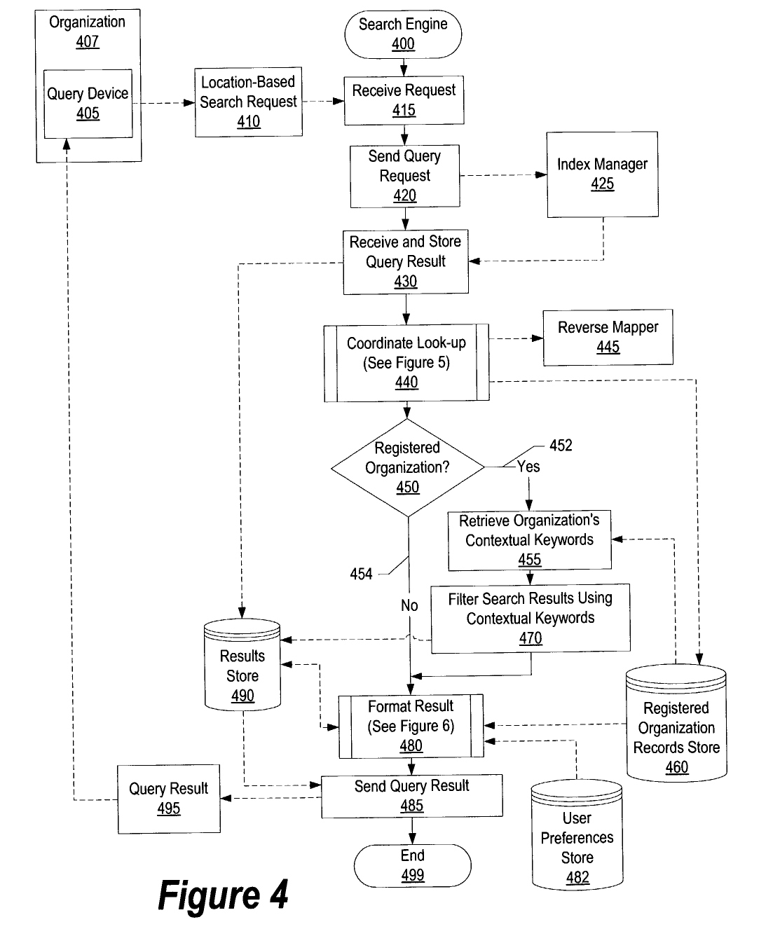

FIG. 4 is a high-level diagram showing steps taken in performing a location-based search request by querying an index manager using a user query request, filtering a query result using one or more contextual keywords, and sending the query result to a query device. The query device, such as query device 405, is located at a particular organization, such as organization 407. Search engine processing commences at 400, whereupon location-based search request 410 is received from query device 405 (step 415). Location-based search request 410 includes geographical coordinates corresponding to organization 407 as well as a user query request. For example, organization 407 may be a baseball field and the user query request includes the word “Bonds”.

Processing sends the query request to index manager 425 at step 420. Index manager 425 is an application that manages a search engine's indexes. A search engine creates the indexes when the search engine is probing the Internet for information. The indexes include URL locations and keywords that are included in the URL's corresponding web page. Processing receives a query result from index manager 425 and stores the query result in results store 490 (step 430). The query result may include information corresponding Barry Bonds the baseball player, savings bonds, and convertible bonds.

Processing uses the geographical coordinates included in location-based search request 410 to determine if organization 407 is registered by comparing the geographical coordinates with organization coordinates included in one or more organization records located in registered organization records store 460 (pre-defined process block 440, see FIG. 5 and corresponding text for further details). Registered organization records store 460 may be stored on a non-volatile storage area, such as a computer hard drive. Processing may also use reverse mapper 445 to identify the name of organization 407 using the geographical coordinates if processing does not identify organization 407's geographical coordinates in registered organization records store 460.

A determination is made as to whether organization 407 is registered (decision 450). If organization 407 is registered, decision 450 branches to “Yes” branch 452 whereupon processing retrieves organization 407's contextual keywords from registered organization records store 460 (step 455). Using the example described above, one of organization 407's contextual keywords may be “baseball”. Organization 407 previously stored the contextual keywords in registered organization records store 460 (see FIG. 1 and corresponding text for further details regarding contextual keyword storage).

Processing filters the query results using the contextual keywords at step 470. Using the example described above, processing uses the word “baseball” to filter the query result which included information corresponding to Barry Bonds, savings bonds, and convertible bonds. In this example, the filtering results in information corresponding to Barry Bonds the baseball player. On the other hand, if organization 407 is not a registered organization, decision 450 branches to “No” branch 454 bypassing contextual keyword filtering steps.

Processing formats the result using user preference information located in user preference store 482 (predefined process block 480, see FIG. 6 and corresponding text for further details). For example, a user may configure the search engine to not send graphical images to his query device due to the query device's small display size. User preference store 482 may be stored on a non-volatile storage area, such as a computer hard drive. If organization 407 is registered, processing adds organization data (i.e. coupon information, product information) corresponding to organization 407 which is located in organization records store 460. Processing sends query result 495 to query device 405 at step 485, and processing ends at 499.

FIG. 5 is a flowchart showing steps taken in determining whether an organization is registered with a search engine. Processing previously received a location-based search request from a query device that included geographical coordinates corresponding to the location of the query device. Coordinate look-up processing commences at 500, whereupon processing matches the geographical coordinates with organization coordinates included in organization records located in registered organization records store 515. If an organization is registered, the organization has an organization record which may include the organization's name and the organization's coordinates.

A determination is made as to whether processing matched the geographical coordinates with one of the organization coordinates (decision 520). If processing matched the query device's coordinates with one of the organization coordinates, decision 520 branches to “Yes” branch 523 whereupon processing sets a registered flag (step 530). Setting the registered flag indicates that the query device is located within a registered organization.

On the other hand, if processing does not match the geographical coordinates with one of the organization coordinates, decision 520 branches to “No” branch 528. An organization may be registered but may not have included organization coordinates information in its corresponding organization record. For example, Starbucks Coffee may have a corporate registration that is under the Starbucks coffee name but does not include each Starbucks location. Processing sends a reverse mapping request to reverse mapper 545 which includes the geographical coordinates. Reverse mapper may be an offsite application that converts geographical coordinates to organization names, such as “Starbucks Coffee”.

Processing receives a response from reverse mapper 545 which includes an organization name corresponding to the query device's coordinates (step 550). Processing matches the organization name with organization names stored in organization records store 515 (step 560). Using the example described above, processing matches “Starbucks Coffee” with each of the organization names located in the organization records.

A determination is made as to whether processing matched the organization name with one of the organization records (decision 570). If processing matched the organization name with one of the organization records, decision 570 branches to “Yes” branch 578 whereupon processing sets the registered flag at step 580. On the other hand, if processing did not match the organization name with one of the organization records, decision 570 branches to “No” branch 572, bypassing register flag setting steps. Coordinate look-up processing returns at 590.

FIG. 6 is a flowchart showing steps taken in using a user's preference information and organization data to format a query result. Processing commences at 600, whereupon processing retrieves a query result from result store 615 (step 610). The query result corresponds to a query request that a user previously requested (see FIGS. 3, 4, and corresponding text for further details regarding query requests).

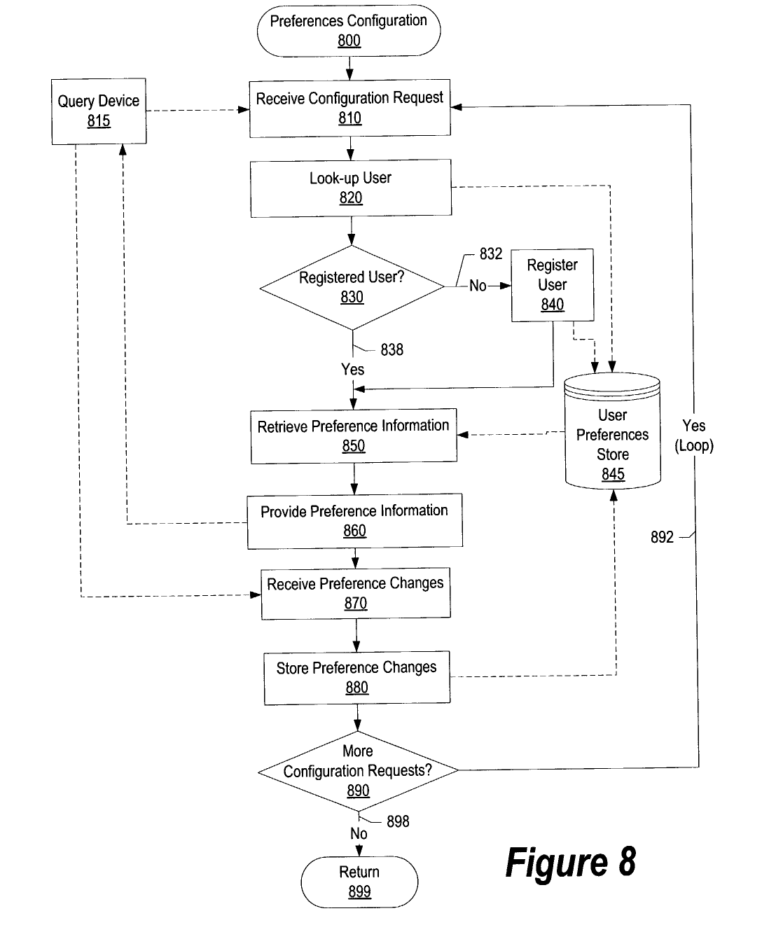

Processing retrieves user preferences from user preferences store 625. A user previously stored preference information in user preferences store 625 (see FIG. 8 and corresponding text for further details regarding preference configuration). For example, a user may configure a search engine to not send graphics to the user's query device because the query device has a small monochrome screen. Processing configures the query result using the user's preferences at step 630. Using the example described above, processing removes graphic information from the query result.

A determination is made as to whether the corresponding organization is registered (decision 640). If the organization is registered, decision 640 branches to “Yes” branch 642 whereupon processing retrieves organization data from registered organization records store 655. For example, the organization may be a grocery store and the organization data may include coupons, product locator information, or recipes. Processing adds the organization data to the query result at step 660. On the other hand, if the organization is not registered, decision 640 branches to “No” branch 648 bypassing organization data addition steps.

A determination is made as to whether a manufacturer included in the user's query request is registered (decision 670). For example, the query request may include the word “delta” and the user may be in a plumbing store wherein processing identifies that the user is interested in delta faucets (see FIGS. 4, 9, and corresponding text for further details regarding organization type identification). If the manufacturer is registered, decision 670 branches to “Yes” branch 672 whereupon processing retrieves manufacturer data from manufacturer data store 680 at step 675. The manufacturer data corresponds to a type of organization where the user is located. Manufacturer data store 680 may be stored on a nonvolatile storage area, such as a computer hard drive. Processing includes the manufacturer data with the query result at step 685. On the other hand, if the manufacturer included in the user's query request is not registered, decision 670 branches to “No” branch 674 bypassing manufacturer data inclusion steps.

Processing stores the query result in result store 615 at step 690 and processing returns at 695.

FIG. 7 is a flowchart showing steps taken in using a query device to send a request to a search engine. The user may use the query device to send configuration preferences to a search engine or to send a user query request to a search engine. Query device processing commences at 700, whereupon the query device receives a request from user 715.

A determination is made as to whether user 715's request is a configuration request or a query request (decision 720). If the user's request is a configuration request, decision 720 branches to “Yes” branch 722. For example, user 715 may wish to configure a search engine to not include graphical images in query results. The query device communicates with search engine 780 to configure user preferences (pre-defined process block 730, see FIG. 8 and corresponding text for further details regarding preferences configuration.

On the other hand, if user 715's request is a query request, decision 720 branches to “No” branch 728 whereupon processing retrieves geographical coordinate information from location device 750 (step 740). Location device 750 is a device that is capable of determining the geographical location of the query device, such as a Global Positioning System (GPS) device. Processing combines user 715's query request with the geographical coordinates at step 760, resulting in a location-based search request. Processing sends the location-based search request to search engine 780 at step 770. The query device may use a network, such as a wireless network, to send the location-based search request to search engine 780.

A determination is made as to whether user 715 has more requests (decision 790). If user 715 has more requests, decision 790 branches to “Yes” branch 792 which loops back to process more user requests. This looping continues until user 715 has no more requests, at which point decision 790 branches to “No” branch 798 whereupon processing ends at 799.

FIG. 8 is a flowchart showing steps taken in a search engine receiving a preferences configuration request from a query device. Preferences configuration processing commences at 800, whereupon processing receives a configuration request from query device 815. Query device 815 may be at a remote location and may be sending the configuration request using a wireless network. Query device 815 may be an electronic device capable of sending requests to a search engine, such as a cellular phone, a computer, or a personal digital assistant (PDA).

Processing looks-up the user using the query device in user preferences store 845 (step 820). Processing may use a user's id or query device 815's id. For example, the configuration request may include a user id corresponding to the user entering the configuration request on query device 815. User preferences store 845 includes a list of registered users (or query devices), and may be stored on a non-volatile storage area, such as a computer hard drive.

A determination is made as to whether the user or query device 815 is registered (decision 830). If the user or query device 815 is not registered, decision 830 branches to “No” branch 832 whereupon processing registers the user in user preferences store 845 (step 840). In one embodiment, an organization model may be such that a user pays a monthly fee to use a contextual based search service, in which case the user registration process includes currency exchange, such as obtaining the user's credit card number.

On the other hand, if the user is registered, decision 830 branches to “Yes” branch 838, bypassing user registration steps. Processing retrieves user preference information from user preferences store 845 at step 850. For example, processing may have various default value settings when a user first registers, and the user may change his particular settings. Processing sends the user preferences to query device 815 using a network, such as a wireless network, at step 860. The user reviews the preferences settings, and processing receives the user's preferences changes from query device 815 at step 870.

Processing stores the preferences changes in user preferences store 845 at step 880. A determination is made as to whether the user has more configuration requests (decision 890). If the user has more configuration requests, decision 890 branches to “Yes” branch 892 which loops back to process the next configuration request. This looping continues until the user has no more configuration requests, at which point decision 890 branches to “No” branch 898. Processing returns at 899.

FIG. 9 is a diagram showing a manufacturer and two organizations sending data to a search engine, such as search engine 900. Search engine 900 includes three storage areas to store manufacturer and organization data in which search engine 900 compares when it receives a location-based search request (see FIGS. 2, 3, 4, and corresponding text for further details regarding location-based search requests).

Manufacturer X 910 subscribes with search engine 900 and provides one or more category types corresponding to products manufacturer X 910 manufactures. For example, manufacturer X 910 may be “Delta Faucets” and have corresponding category types such as plumbing, hardware, and home improvement. Search engine 900 receives manufacturer X 910's category type information, and stores it in look-up table 970 located in manufacturing type store 960. Manufacturing type store 960 may be stored on a non-volatile storage area, such as a computer hard drive.

Manufacturer X 910 may wish to provide a user with information corresponding to the user's location. For example, if the user is located in a plumbing store, manufacturer X 910 may wish to provide the user with a discount coupon. Manufacturer X 910 sends manufacturing data and corresponding category match types to search engine 900. Search engine 900 receives manufacturer X 910's manufacturing data information and stores it in look-up table 990 located in manufacturing data store 980. Manufacturing data store 980 may be stored on a non-volatile storage area, such as a computer hard drive.

Organizations, such as organization A 920 and organization B 930, may wish to subscribe with search engine 900 as well. Organization A 920 and organization B 930 subscribe with search engine 900, and provide category types corresponding to their organization type (i.e. type of store). For example, organization A 920 may be a plumbing store and organization B 930 may be a hardware store. Search engine 900 receives organization A 920's and organization B 930's category type information, and stores them in look-up table 950 located in organization type store 940. Organization type store 940 may be stored on a non-volatile storage area, such as a computer hard drive.

When search engine 900 receives a location-based search request from a user, search engine 900 analyzes geographical coordinates included in the location-based search request to identify which organization the user is located. Search engine 900 uses look-up table 950 to ascertain the identified organization's category type. For example, the search engine may determine that the user is located at organization A 920 shown in FIG. 9 and look-up table 950 identifies organization A 920 as a plumbing store.

Search engine 900 uses a user query request included in the location-based search request to identify a manufacturer that interest the user. Search engine 900 identifies the manufacturer's corresponding category types using look-up table 970. Using the example described above, manufacturer X 910 may be “Delta Faucets” and the user's query request includes “Delta”. In this example, search engine 900 uses look-up table 970 to determine that Delta Faucets' corresponding category types are “plumbing”, “hardware”, and “home improvement”.

Search engine 900 uses look-up table 990 to determine the manufacturing data to include in a query result corresponding to the location-based search request. Using the example described above, since the user is located at a plumbing store, look-up table 990 shows that search engine 900 includes a faucet coupon as well as advertisement in the query request. Using another example, look-up table 990 shows that search engine 900 does not include the faucet coupon in a query result if a user is not located at a plumbing store, but does include advertisement information.

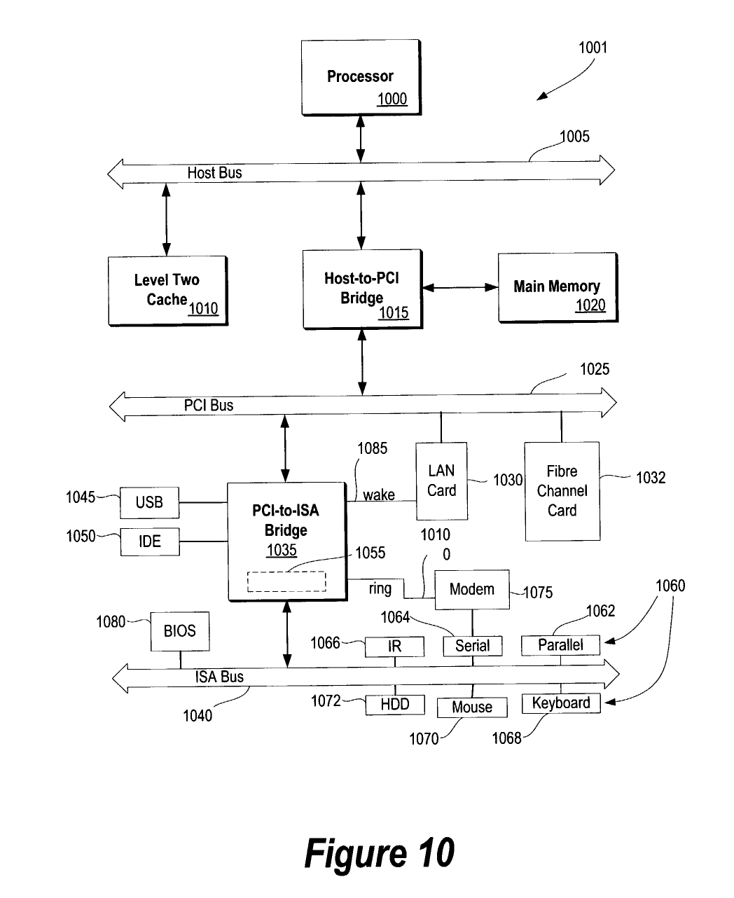

FIG. 10 illustrates information handling system 1001 which is a simplified example of a computer system capable of performing the invention described herein. Computer system 1001 includes processor 1000 which is coupled to host bus 1005. A level two (L2) cache memory 1010 is also coupled to the host bus 1005. Host-to-PCI bridge 1015 is coupled to main memory 1020, includes cache memory and main memory control functions, and provides bus control to handle transfers among PCI bus 1025, processor 1000, L2 cache 1010, main memory 1020, and host bus 1005. PCI bus 1025 provides an interface for a variety of devices including, for example, LAN card 1030. PCI-to-ISA bridge 1035 provides bus control to handle transfers between PCI bus 1025 and ISA bus 1040, universal serial bus (USB) functionality 1045, IDE device functionality 1050, power management functionality 1055, and can include other functional elements not shown, such as a real-time clock (RTC), DMA control, interrupt support, and system management bus support. Peripheral devices and input/output (I/O) devices can be attached to various interfaces 1060 (e.g., parallel interface 1062, serial interface 1064, infrared (IR) interface 1066, keyboard interface 1068, mouse interface 1070, and fixed disk (HDD) 1072) coupled to ISA bus 1040. Alternatively, many I/O devices can be accommodated by a super I/O controller (not shown) attached to ISA bus 1040.

BIOS 1080 is coupled to ISA bus 1040, and incorporates the necessary processor executable code for a variety of low-level system functions and system boot functions. BIOS 1080 can be stored in any computer readable medium, including magnetic storage media, optical storage media, flash memory, random access memory, read only memory, and communications media conveying signals encoding the instructions (e.g., signals from a network). In order to attach computer system 1001 to another computer system to copy files over a network, LAN card 1030 is coupled to PCI bus 1025 and to PCI-to-ISA bridge 1035. Similarly, to connect computer system 1001 to an ISP to connect to the Internet using a telephone line connection, modem 1075 is connected to serial port 1064 and PCI-to-ISA Bridge 1035.

While the computer system described in FIG. 10 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of performing a location-based search request, said method comprising:
receiving the location-based search request from a query device, wherein the location-based search request includes a user query request and geographical coordinates, the geographical coordinates corresponding to the location of the query device;
retrieving one or more contextual keywords based upon the geographical coordinates;
searching one or more indices using at least one of the contextual keywords and the user query request;
receiving a query result in response to the searching; and
sending the query result to the query device.

2. The method as described in claim 1 further comprising:
combining one or more of the contextual keywords with the user query request, the combining resulting in a contextual query request; and
performing the searching using the contextual query request.

3. The method as described in claim 1 wherein the searching further comprises:
searching one or more of the indices using the user query request, the searching resulting in a user query result; and
filtering the user query result using one or more of the contextual keywords, the filtering resulting in the query result.

4. The method as described in claim 1 further comprising:
receiving a subscription request from a subscriber, wherein the receiving includes one or more contextual keywords; and
storing the subscription request in a nonvolatile storage area.

5. The method as described in claim 4 further comprising:
determining whether a subscriber corresponds to the geographical coordinates;
retrieving data corresponding to the subscriber based on the determination; and
including the retrieved data with the query result.

6. The method as described in claim 5 wherein the retrieved data is selected from the group consisting of organization data and manufacturing data.

7. The method as described in claim 1 wherein the determination further comprises:
matching the geographical coordinates with one or more organization coordinates, wherein the organization coordinates are included in an organization record; and
providing the geographical coordinates to a reverse mapper based upon the matching.

8. The method as described in claim 1 further comprising:
receiving, at the query device, the user query request;
retrieving the geographical coordinates from a location device; and
combining the geographical coordinates with the user query request, the combining resulting in the location-based search request.

9. An information handling system comprising:
one or more processors;
a memory accessible by the processors;
one or more nonvolatile storage devices accessible by the processors; and
a search request handling tool to perform location-based searches, the search request handling tool including:
means for receiving a location-based search request from a query device, wherein the location-based search request includes a user query request and geographical coordinates, the geographical coordinates corresponding to the location of the query device;
means for retrieving one or more contextual keywords based upon the geographical coordinates;
means for searching one or more indices located on one or more of the nonvolatile storage devices using at least one of the contextual keywords and the user query request;
means for receiving a query result in response to the searching; and
means for sending the query result to the query device.

10. The information handling system as described in claim 9 further comprising:
means for combining one or more of the contextual keywords with the user query request, the combining resulting in a contextual query request; and
means for performing the searching using the contextual query request.

11. The information handling system as described in claim 9 wherein the searching further comprises:
means for searching one or more of the indices located on one or more of the nonvolatile storage devices using the user query request, the searching resulting in a user query result; and
means for filtering the user query result using one or more of the contextual keywords, the filtering resulting in the query result.

12. The information handling system as described in claim 9 further comprising:
means for receiving a subscription request from a subscriber, wherein the receiving includes one or more contextual keywords; and
means for storing the subscription request on one of the nonvolatile storage devices.

13. The information handling system as described in claim 12 further comprising:
means for determining whether a subscriber corresponds to the geographical coordinates;
means for retrieving data from one of the nonvolatile storage devices corresponding to the subscriber based on the determination; and
means for including the retrieved data with the query result.

14. The information handling system as described in claim 13 wherein the retrieved data is selected from the group consisting of organization data and manufacturing data.

15. A computer program product stored on a computer operable media for performing a location-based search request, said computer program product comprising:
means for receiving the location-based search request from a query device, wherein the location-based search request includes a user query request and geographical coordinates, the geographical coordinates corresponding to the location of the query device;
means for retrieving one or more contextual keywords based upon the geographical coordinates;
means for searching one or more indices using at least one of the contextual keywords and the user query request;
means for receiving a query result in response to the searching; and
means for sending the query result to the query device.

16. The computer program product as described in claim 15 further comprising:
means for combining one or more of the contextual keywords with the user query request, the combining resulting in a contextual query request; and
means for performing the searching using the contextual query request.

17. The computer program product as described in claim 15 wherein the searching further comprises:
means for searching one or more of the indices using the user query request, the searching resulting in a user query result; and
means for filtering the user query result using one or more of the contextual keywords, the filtering resulting in the query result.

18. The computer program product as described in claim 15 further comprising:
means for receiving a subscription request from a subscriber, wherein the receiving includes one or more contextual keywords; and
means for storing the subscription request in a nonvolatile storage area.

19. The computer program product as described in claim 18 further comprising:
means for determining whether a subscriber corresponds to the geographical coordinates;
means for retrieving data corresponding to the subscriber based on the determination; and
means for including the retrieved data with the query result.

20. The computer program product as described in claim 19 wherein the retrieved data is selected from the group consisting of organization data and manufacturing data.
